(19) United States
(12) Patent Application Publication
(10) Pub. No.: US 2026/0122745 A1
(43) Pub. Date: Apr. 30, 2026

(54) MULTI-MODAL PROGRAMMABLE SOUND-RESPONSIVE LIGHTING UNIT AND APPLICATION

(71) Applicant: Varsity Music, Inc., Toledo, OH (US)

(72) Inventors: Jacob Schmieder, Toledo, OH (US); Jack Evans, Ames, IA (US); Logan TeKolste, Stuart, IA (US); Samantha Lavin, Madison, WI (US); Nathaniel T. Paskach, Pella, IA (US)

(21) Appl. No.: 18/926,474

(22) Filed: Oct. 25, 2024

Related U.S. Application Data
(60) Provisional application No. 63/581,028, filed on Sep. 7, 2023.

(51) Int. Cl. H05B 47/12; H05B 45/20

(52) U.S. Cl. CPC H05B 47/12; H05B 45/20

(57) ABSTRACT

A multi-modal programmable sound-responsive lighting system includes a set of lighting units to facilitate various functions associated with practices and performances by a marching band and individual musicians. Each lighting unit may be designed to enable attachment to a musical instrument and/or to an individual performer and may produce various lighting effects according to programmable timing and/or color settings.

### CROSS-REFERENCE TO RELATED APPLICATION

This application claims the benefit of U.S. Provisional Patent Application No. 63/581,028 filed on Sep. 7, 2023, which is incorporated by reference herein.

### BACKGROUND

Marching bands commonly serve as entertainment at sporting events, parades, carnivals, rallies, or as standalone performances. In addition to musical performances, marching bands often create various visual elements through different formations, coordinated movements, and/or electronically-assisted visual effects.

### BRIEF DESCRIPTION OF THE DRAWINGS

FIG. 1 is a block diagram of a computing environment for facilitating operation of a set of multi-modal programmable sound-responsive lighting units.

FIG. 2 illustrates an example embodiment of form factors for a main unit and a light unit.

FIG. 3 is a block diagram illustrating an example architecture for a lighting unit.

FIG. 4 illustrates various examples of lighting units attached to instruments.

FIG. 5 is a flowchart illustrating an example embodiment of a process for operating a lighting unit.

FIG. 6 illustrates an example embodiment of a process performed by the lighting unit when operating in the note recognition mode.

FIG. 7 is an example embodiment of a user interface screen of the mobile device for configuring settings associated with the note recognition mode.

FIG. 8 illustrates an example embodiment of a process performed by the lighting unit when operating in the tuning mode.

FIG. 9 is an example embodiment of a user interface screen of the mobile device for configuring settings associated with the tuning mode.

FIG. 10 is an example embodiment of a flowchart associated with operating the lighting unit in a performance mode.

FIG. 11 illustrates an example user interface for a mobile device associated with loading a performance file.

FIG. 12 shows another user interface associated with the performance mode.

FIG. 13 is a example screen associated with a mobile application that operates in conjunction with a lighting unit.

FIG. 14A is a first example view of a settings page associated with a mobile application that operates in conjunction with a lighting unit.

FIG. 14B is a second example view of a settings page associated with a mobile application that operates in conjunction with a lighting unit.

FIG. 15 is an example user interface flow associated with a mobile application.

### DETAILED DESCRIPTION

A multi-modal programmable sound-responsive lighting system includes a set of lighting units to facilitate various functions associated with practices and performances by a marching band and individual musicians. Each lighting unit may be designed to enable attachment to a musical instrument and/or to an individual performer and may produce various lighting effects according to programmable timing and/or color settings.

The lighting units may operate according to multiple operation modes. In some example modes, the lighting units may be sound-responsive such that the color and/or timing of light displays are based at least in part on detected audio tones. Such modes may be used to facilitate tuning functions or to automate displayed color patterns in coordination with a musical score being performed. In other modes, the lighting system may be programmable to enable display of pre-programmed lighting patterns across a set of lighting units associated with respective members of a marching band during a performance. In further embodiments, the lighting units may be utilized in a gamified practice session to analyze accuracy of a performance relative to a musical score and generating lighting output indicative of the accuracy.

In an embodiment, the lighting system operates in conjunction with one or more management applications that facilitates creation of a marching band performance including preprogrammed lighting patterns. Here, a performance may be structured as a sequence of sets that each comprises a particular field formation of the marching band members in conjunction with a musical score or sequence of scores. A set may have a particular duration, which may be defined relative to the musical score being performed. For example, a set may be designed to last for an entire piece, multiple pieces, or a specific number of bars of a piece. A performance furthermore specifies how each member moves between sets (e.g., the respective paths that each member takes to transition between formations and the relative timing of the transitional movements in relation to the musical score). The described lighting system enables creation of lighting patterns associated with the sets and transitions between them. The lighting patterns can be downloaded to individual lighting units worn by band member or affixed to instruments to implement the lighting patterns during a performance.

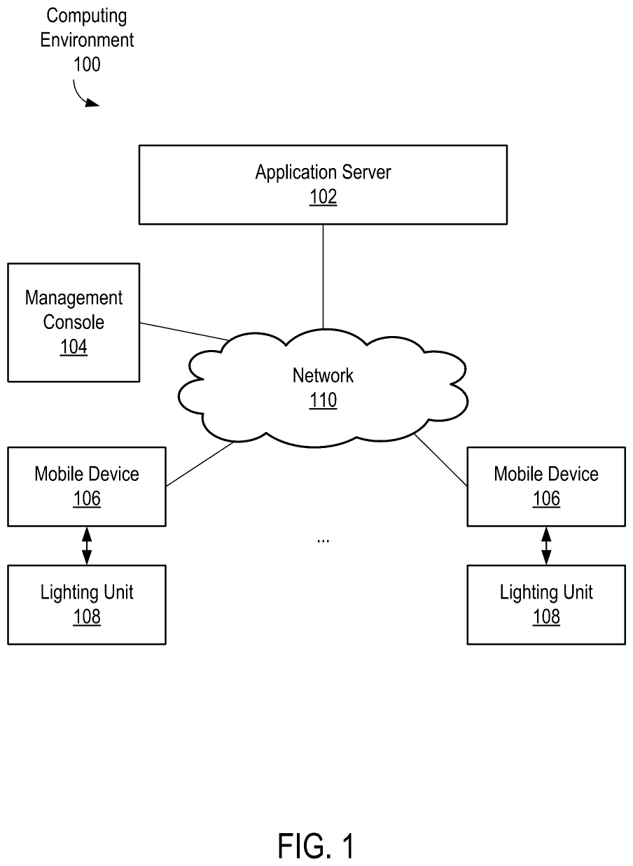

FIG. 1 is a block diagram of a computing environment 100 for facilitating operation of a set of multi-modal programmable sound-responsive lighting units 108. The computing environment 100 includes an application server 102, a management console 104, one or more mobile devices 106, and one or more lighting units 108, coupled by a network 110.

The management console 104 facilitates execution of a management application for managing various aspects of the set of lighting units 108 and associated mobile devices 106. The management application may comprise a web application accessible via a web browser of the management console 104, or may comprise an executable application installed on the management console 104. In an embodiment, the management console 104 may comprise a desktop or laptop computer. In other embodiments, the management console 104 may comprise any computing device such as a mobile phone, tablet, gaming console, head mounted display (HMD), or other computing device. Functions attributed to the management application described herein may be implemented as a set of instructions stored to a non-transitory computer-readable storage medium that are executed by one or more processors of the management console 104.

The management console 104 provides various user interface tools to enable functions such as managing users (e.g., individual band members), groups of users (e.g., marching bands), and creating shows that utilize the lighting units 108. For example, the management console 104 may enable creating, storing, and updating of profiles corresponding to each member of a marching band including information such as instrument and role (e.g., first trumpet, second trumpet, bass drum, clarinet, etc.) and unique identifiers that will be used to identify positions and movement patterns of each member during a marching band performance. The management console 104 may furthermore enable creation, viewing, and/or management of a performance. For example, the management console 104 may enable creation of different sets, transitions between sets, and lighting patterns to be displayed associated with the sets and the transitions in association with one or more musical scores. In association with a performance, each individual band member (as identifier by a specific identifier) may be assigned a specific musical score associated with their instrument/role, specific positions and movement patterns associated with the sequence of sets and transitions, and a specific lighting sequence to be programmed to that member's corresponding lighting unit 108.

The management console 104 may enable a creator to input high-level lighting effects that the management application may automatically translate into sequences of lighting commands for the individual lighting units 108. For example, a creator may specify an effect at a particular time in the performance such as a flash, a wipe effect across a formation, or a solid color. Patterns may include different lighting units 108 displaying the individually configured colors, brightness levels, on-off patterns, or other coordinated effects. The management application may then convert these high-level effects to individual lighting sequences to be implemented by different lighting units 108 depending on their respective positions in different sets. Furthermore, the management console 104 may enable a creator to manually configure lighting commands for a select performer with respect to different time periods of a performance (based on actual time or relative to a musical score).

In one embodiment, the lighting system may enable programming of a performance in which the lighting patterns within each set are separately preprogrammed to follow a particular time-based pattern. Switching between sets may be initiated during the performance via a button press or other signal to a lighting control system. Preprogrammed performances may be exported via the network 110 and saved to the application server 102.

The mobile device 106 communicatively couples to respective lighting units 108 to enable various control functions of the lighting units 108. The mobile device 106 may execute a mobile application that includes various modes associated with different types of lighting operations. When the user switches between modes, a control signal may be communicated to the lighting unit 108 to enable operation in the selected mode. Furthermore, various control settings configured via the mobile device 106 in association with the different modes may be communicated to the lighting unit 108. In an embodiment, the mobile device 106 may furthermore include an interface control to enable reading from the lighting unit 108 such that the current configured mode and/or settings may be viewed and/or changed on the mobile device 106. The mobile device 106 may be coupled to a corresponding lighting unit 108 via a peer-to-peer wireless connection (e.g., Bluetooth or WiFi direct) or via a wired connection (e.g., USB or Ethernet). Alternatively, the mobile device 106 may communicate with the lighting unit 108 via respective connections to the network 110.

In a note recognition mode, a user interface enables a user to choose a key they are playing in and select colors that coordinates to each note. The color can be changed via RBG codes, HEX codes, or via a slider. All notes can be set to be the same color, set to default colors that are different for each note (e.g., according to deaf note color standards), or set to custom-defined colors for each note. Once configured, the settings may be communicated to the lighting unit 108 for operating in the note recognition mode according to the defined color settings.

In a tuning mode, the user interface enables controls associated with various tuning functions in which the lighting unit 108 can detect pitch of a tone, determines its tunning accuracy, and displays the programmed colors to indicate the tuning results. Here, the user can select a frequency they want to tune to and a tolerance of the tuning (e.g., in cents). The user interface may furthermore enable the user to select colors to be used to indicate whether a detected tone is sharp, in tune, or flat. Settings in the user interface may be downloaded to the lighting unit 108.

A performance mode may facilitate a performance downloaded from the application server 102. Here, the user may sign into the mobile application and connect to a specific group (e.g., a marching band). The user can then download relevant instructions for a preprogrammed performances from the application server 102 corresponding to the member's identifier. The downloaded instructions may include information about the musical score, the member's assigned positions and transitions for sets of the performance, and a set of control commands for controlling a connected lightning unit in association with the performance.

In a settings mode, the user can configure various settings of the mobile device 106 and/or the connected lighting unit 108. For example, the user can select their instrument and change various other settings.

In a game mode, the mobile device 106 and lighting unit 108 may be configured to enable a game-like practice session in which a user can practice given music and be scored based on their accuracy (determined based on tones detected by the lighting unit 108 relative to a musical score). The lighting system may employ various lighting colors and patterns to indicate errors and/or different levels of performance.

The lighting unit 108 outputs various light color and patterns based on detected sound and/or control information from the mobile device 106. The lighting unit 108 may store information about a performance for one specific performer and may be controlled to advance between sets in response to a cue received via radio. The lightning unit may furthermore include a microphone and processing elements to enable it to recognize pitch and facilitate various operations of the note recognition and tuning modes described above.

In an example implementation, the lighting unit 108 includes a main unit and a light unit. The units may be directly communicatively coupled (e.g., via an Ethernet connection, other wired connection, or wireless connection). The main unit includes a communication interface that connects to the mobile device 106 (e.g., via Bluetooth). The light unit may have various form factors that may be interchangeably connected to the main unit. These different variations may be selected dependent on the desired attachment mechanism (e.g., to a specific type of instrument, to the performer, etc.) or based on various other considerations.

In one variation, the light unit includes a clip with one or more LEDs for clipping to an instrument or other attachment point. Another variation may include a circular lighting device with one or more LEDs that can be attached via magnet to clothing. Either or both of these variations (or other variations) may include a microphone for performing pitch identification. Some variations of the light unit may omit the microphone and may be utilized only for performance mode or other operations that do not depend on pitch detection.

The main unit connects to the mobile device 106 (e.g., via Bluetooth) and is able to upload and download information from the mobile app. In an example connectivity scheme, a connection to the mobile device 106 may be initiated by holding a power button for a predefined time period (e.g., 2 seconds) to enter a pairing mode. Once the main unit is in the pairing mode, the main unit may control the light unit to display a particular color and timing pattern indicative of the pairing mode (e.g., flashing blue).

In an embodiment, the main unit may be WiFi and radio capable and utilize WiFi for firmware updates. For example, if the power button is held for a predefined time period (e.g., six seconds), the main unit may initiate a WiFi network that can be accessed via the mobile device 106 (or management console 104) to enable transfer of a firmware update file. In an embodiment, the light unit may be controlled to operate according to a predefined pattern (e.g., pulsing orange) to indicate when it is in the firmware update mode.

In an embodiment, the main unit may furthermore include a select button that may be employed to set the mode of the lighting unit 108. For example, in one control scheme each press of the select button advances to the next mode in a predefined circular sequence. The main unit may furthermore control the light unit to output light according to a color and/or timing scheme indicative of the mode selection. For example, a flash of white light once, twice, or three times may correspond to note recognition, tuning, and show modes respectively.

The application server 102 comprises one or more computing devices for supporting operations of the management console 104 and mobile devices 106. For example, the application server 102 may store performance files associated with preprogrammed performances and may store profile information pertaining to users and groups. The application server 102 may furthermore host a web application accessible by the management console 104 and/or a file server for downloading a management application and/or mobile applications associated with operations of the lighting system.

The application server 102 may be implemented as one or more traditional physical servers and/or one or more virtual machines. The application server 102 may comprise one or more enterprise managed processing and/or storage devices or may comprise cloud processing and storage technologies, or a combination thereof. For example, in a cloud-based implementation, the application server 102 may include multiple distributed computing and storage devices managed by a cloud service provider. In various implementations, the application server 102 may comprise one or more processors and one or more non-transitory computer-readable storage mediums that store instructions executable by the one or more processors for carrying out the functions attributed to the application server 102 herein.

The one or more networks 110 provides communication pathways between the application server 102, the management console 104, and the mobile devices 106. The network(s) 110 may include one or more local area networks (LANs) and/or one or more wide area networks (WANs) including the Internet. Connections via the one or more networks 110 may involve one or more wireless communication technologies such as satellite, WiFi, Bluetooth, or cellular connections, and/or one or more wired communication technologies such as Ethernet, universal serial bus (USB), etc. The one or more networks 110 may furthermore be implemented using various network devices that facilitate such connections such as routers, switches, modems, firewalls, or other network architecture.

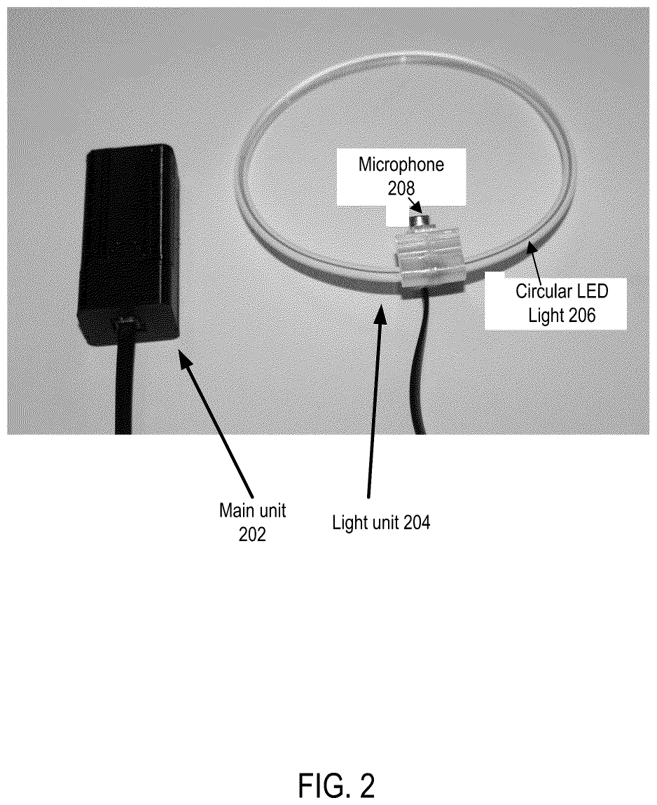

FIG. 2 illustrates an example embodiment of form factors for a main unit 202 and light unit 204. In this example, the light unit 204 includes a circular LED light 206 with an integrated microphone 208 and Ethernet connection to the main unit 202. The light units 204 may be attached to the instruments via plastic clips or other securing mechanisms. The attachment mechanism may be different for different types of instruments, and the lighting units 108 may attach to different parts of different instruments. For example, for brass instruments, the lighting units 108 may be attached to the bell, while on woodwind instruments, they may attach to other various parts of the instruments.

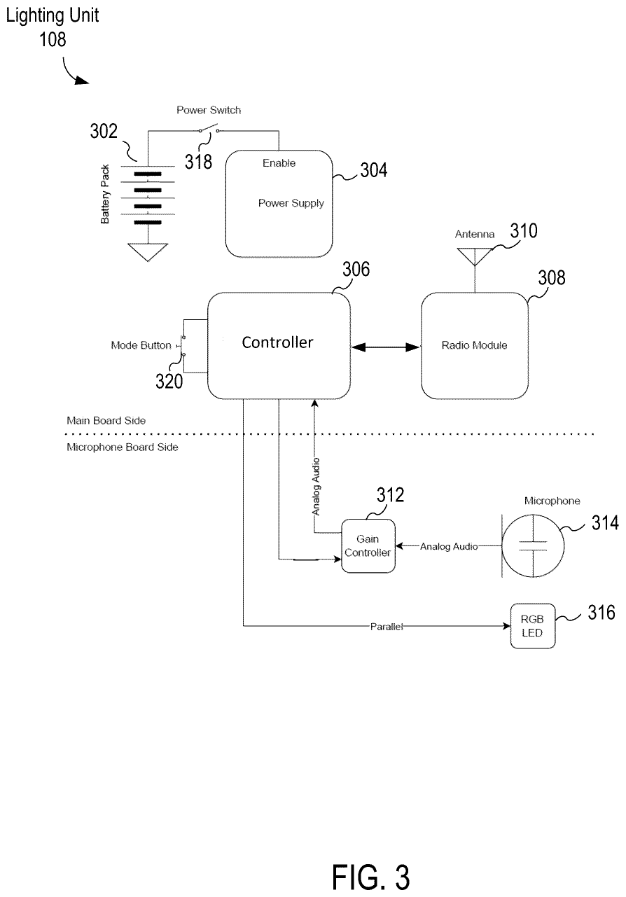

FIG. 3 is a block diagram illustrating an example architecture for a lighting unit 108. In this example, the lighting unit 108 includes a battery pack 302, a power supply 304, a controller 306, a radio module 308, an antenna 310, a gain controller 312, a microphone 314, one or more LEDs 316, and several control switch (e.g., a power switch 318 and a mode button 320).

The power supply 304 generates a supply voltage from the battery pack 302 for powering various electronics of the lighting unit 108. The power switch 318 (controlled by a button, knob, or other control) connects between the battery pack 302 and the power supply 304 to enable power to be connected or disconnected dependent on the switch position.

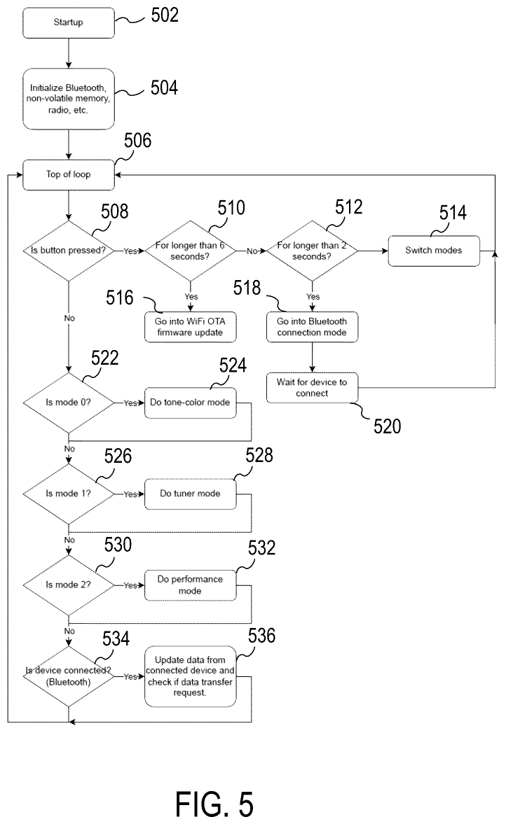

The controller 306 may comprise a microcontroller, general purpose processor, application specific integrated circuit (ASIC), field programmable gate array (FPGA) or other control device for controlling the radio module 308, gain controller 312, and LEDs 316. The controller 306 may facilitate communication of data and/or commands with the mobile device 106 via the radio module 308 (and antenna 310). In an embodiment, the controller 306 communicates with the radio module 3-9 via an serial link, such as a serial peripheral interface (SPI) link or other protocol. The controller 306 may furthermore control the LEDs 316 by configuring currents driving different color LEDs via a set of parallel lines. The controller 306 may also receive analog audio input from the microphone 314 via the gain controller 312 and may generate control signals (e.g., sent via an I2C link) for controlling the gain controller 312 (e.g., to adjust the gain, filtering parameters, etc.). The controller 306 may furthermore receive direct input via the mode button 320 to cause it to switch between the different operating modes described herein. Specific functions associated with the various modes that may be facilitated by the controller are described in further detail below with respect to FIGS. 5, 6, 8, and 10.

The radio module 308 may comprise a Bluetooth module, a WiFi module, a cellular connectivity module (e.g., 3G, 4G, 5G) or a combination thereof for connecting directly to the mobile device 106 and/or connecting to the network 110.

The microphone 314 may be utilized in the tone recognition and tuning modes to capture analog audio. The gain controller 312 may apply a gain or other filters to the received audio before sending it to the controller 306.

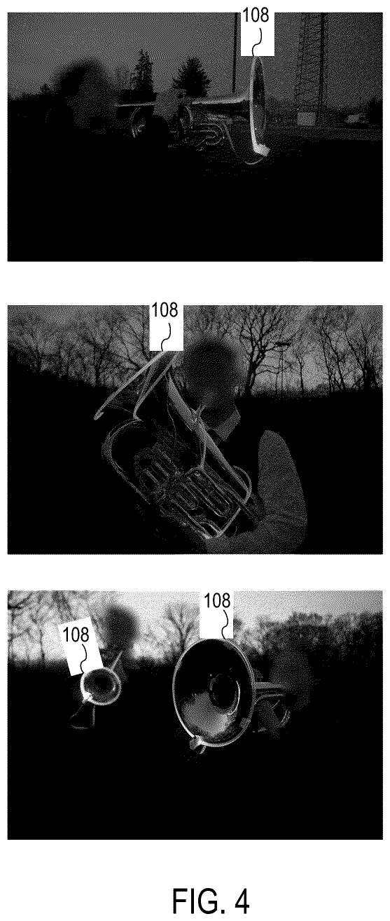

FIG. 4 illustrates various examples of lighting units 108 attached to instruments. The lightning units 108 may be available in various sizes and form factors to enable attachment to different types of instruments. The lighting unit 108 may be structured to attach via various clipping mechanisms, adhesives, or other securing mechanisms.

FIG. 5 is a flowchart illustrating an example embodiment of a process for operating a lighting unit 108. Upon startup 502 at power on, the lighting unit 108 may initialize 504 Bluetooth and/or other radio and read from non-volatile memory. A loop 506 is then performed associated with mode selection. A mode select button (which may double as power button) may initiate 516 firmware updates when a button press is detected 508 and is held 510 for a first predefined time period (e.g., 6 seconds) and otherwise may go into a Bluetooth connection mode 518 and wait for the device to connect 520 when held 512 for a shorter time period (e.g., 2 seconds). Otherwise, if the mode select button is pressed and released, the lighting unit 108 may switch 514 to a next mode in a circular sequence. For example, the lighting unit 108 may select between a mode 0 522 corresponding to a note recognition (tone-color) mode 524, a mode 1 526 corresponding to a tuner mode 528, and a mode 2 530 corresponding to a performance mode 532 as described above. Otherwise, the lighting unit 108 may detect 534 if it is connected and update 536 data from the connected device in response to a data transfer request.

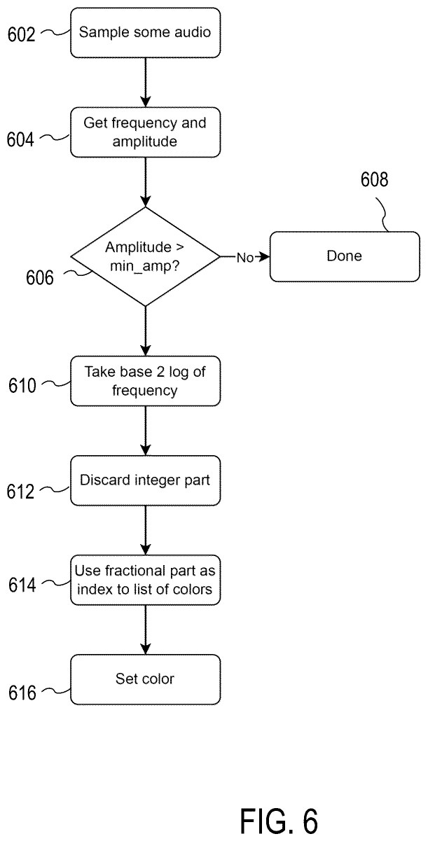

FIG. 6 illustrates an example embodiment of a process performed by the lighting unit 108 when operating in the note recognition mode. The lighting unit 108 obtains 602 an audio sample via the microphone and computes 604 the frequency and amplitude of the sample. If the amplitude is not sufficiently large (e.g., over a minimum threshold amplitude) 606, the lighting unit 108 ignores the sample and the process ends 608. Otherwise, the lighting unit 108 determines the musical tone (ignoring the octave) by determining 610 the base 2 log of the frequency and discarding 612 the integer portion, which effectively removes the musical octave and leaves a frequency corresponding to the musical tone independent of octave. The tone may then be mapped 614 to a programmed color based on the settings downloaded from the mobile device 106. The lighting unit 108 may control 616 the LEDs to set the configured color.

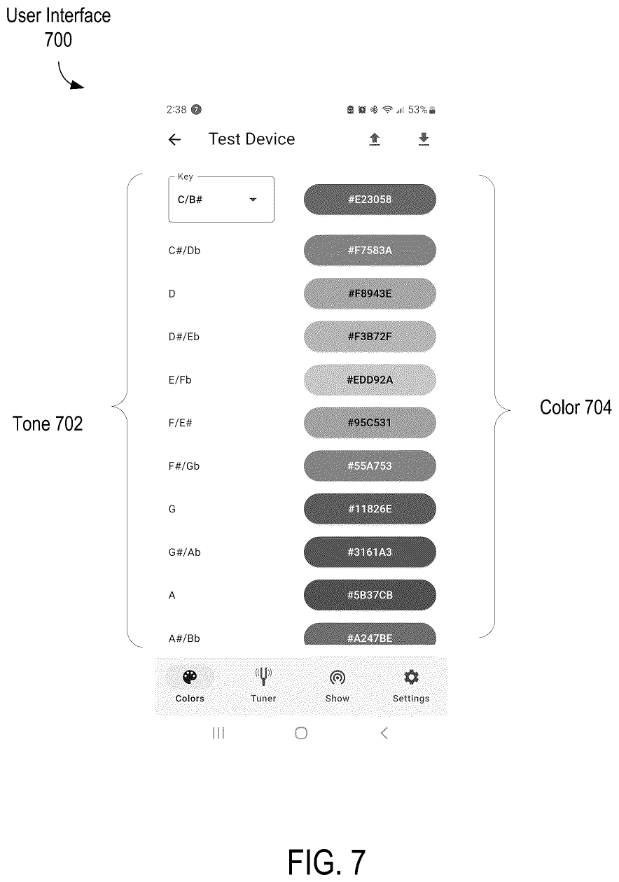

FIG. 7 is an example embodiment of a user interface screen 700 of the mobile device 106 for configuring settings associated with the note recognition mode. Here, the user interface screen may list the various musical tones (i.e., each note of the chromatic scale) 702 and provide a control to enable the user to configure a specific color 706 to be displayed when that note is detected by the lighting unit 108. Colors 706 may be specified by selection from a color chart or by entering a hexadecimal representation of the color.

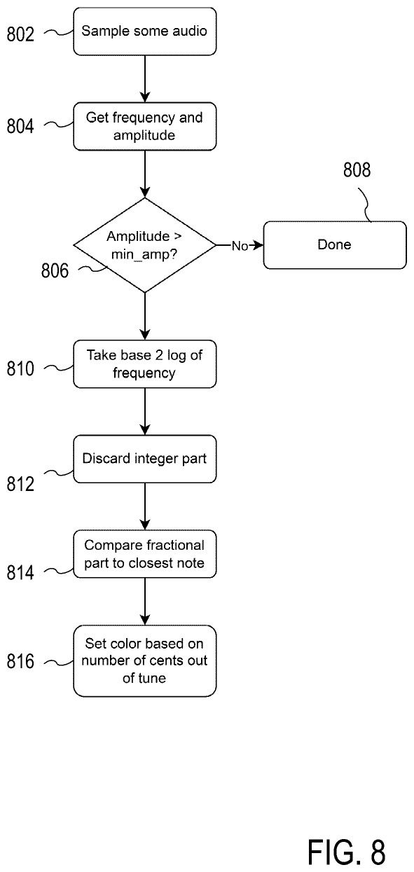

FIG. 8 illustrates an example embodiment of a process performed by the lighting unit 108 when operating in the tuning mode. The lighting unit 108 obtains 802 an audio sample via the microphone and computes 804 the frequency and amplitude of the sample. If the amplitude is not sufficiently large (e.g., over a minimum threshold amplitude) 806, the lighting unit 108 ignores the sample and the process ends 808. Otherwise, the lighting unit 108 determines a reference pitch representing the closest musical tone by taking 810 the base 2 log of the frequency and discarding 812 the integer portion (ignoring the octave). The device then compares 814 the detected pitch to the reference pitch. The lighting unit 108 maps 816 the difference (e.g., in cents) to a color and controls the LEDs accordingly to visually indicate the tuning performance.

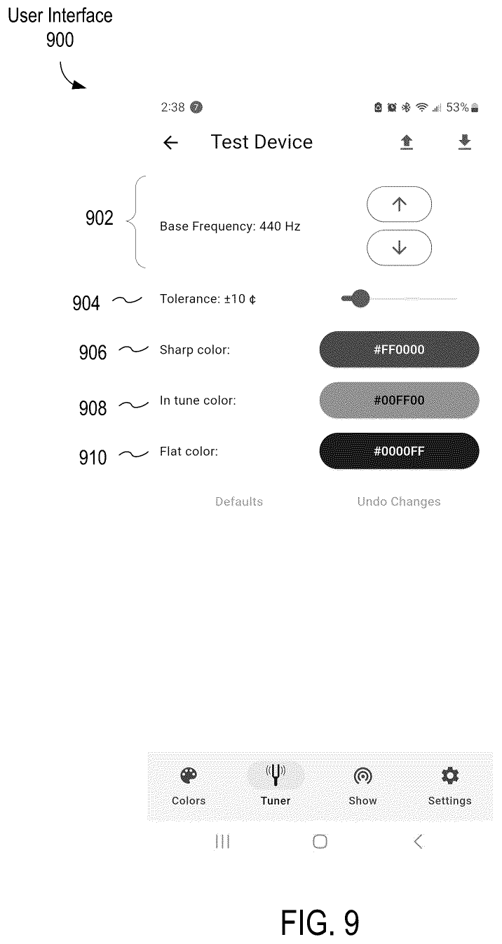

FIG. 9 is an example embodiment of a user interface screen 900 of the mobile device 106 for configuring settings associated with the tuning mode. Here, the user interface screen may include controls 902 for setting of a base frequencies for different notes, controls 904 for setting tolerance, and controls 906, 908, 910 for associating specific colors with detecting sharp, in tune, or flat pitches relative to the base frequencies. Colors may be specified by selection from a color chart or by entering a hexadecimal representation of the color.

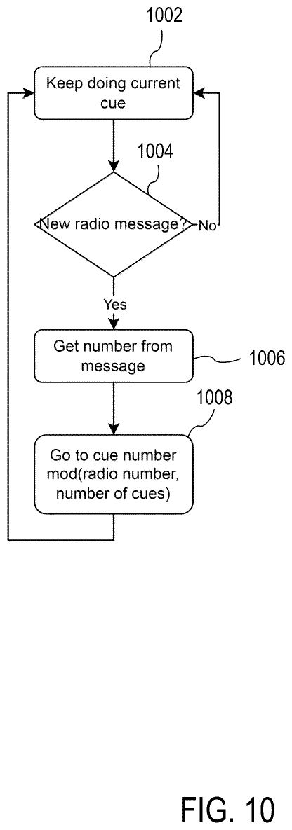

FIG. 10 is an example embodiment of a flowchart associated with operating the lighting unit 108 in a performance mode. In this example, the lighting unit 108 is programmed to execute a lighting pattern associated with a current set. The lighting unit 108 keeps 1002 during the current cue until it receives 1004 a control signal via a radio message to advance to a different set, identified by getting 1006 a cue number in the message. In response, the lighting unit 108 loads 1008 the control sequence associated with the cue number and controls the LEDs accordingly.

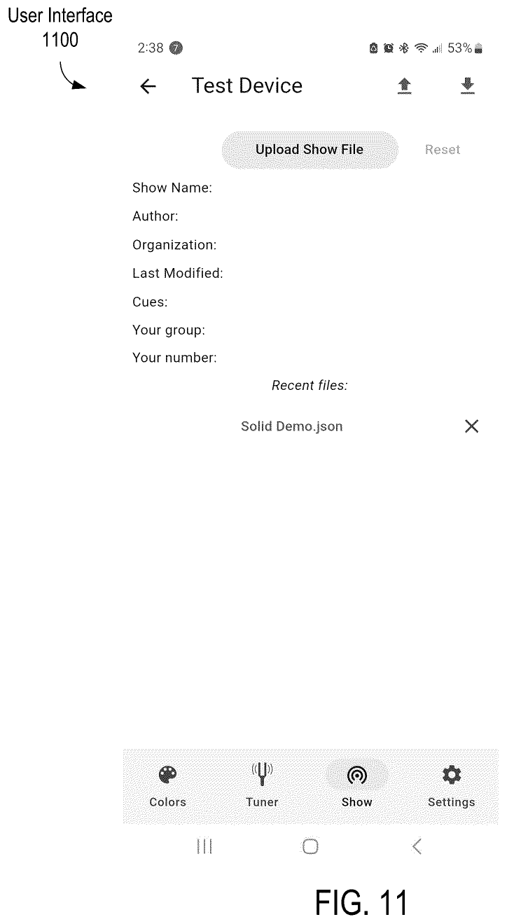

FIG. 11 illustrates an example user interface 1100 for a mobile device 106 associated with loading a performance file. The interface may show various information about the performance, and a control button to upload the show file to the lighting unit 108.

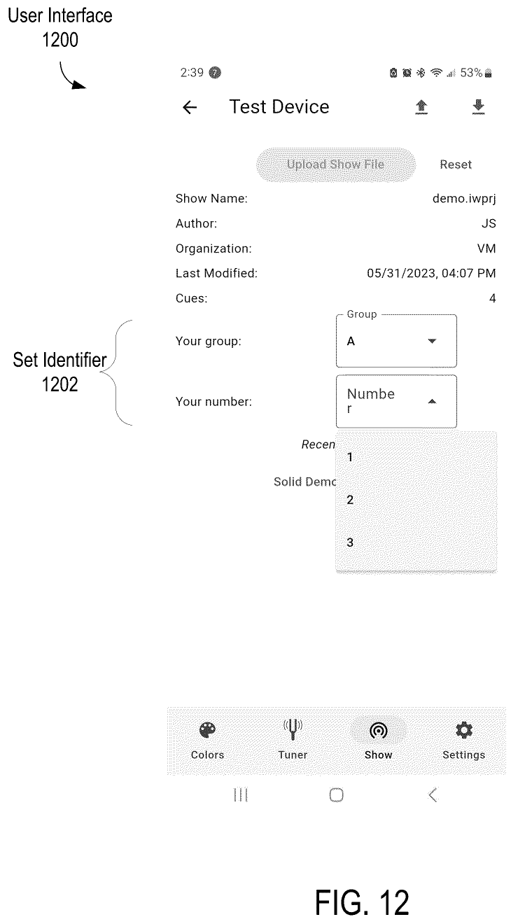

FIG. 12 shows another user interface 1200 associated with the performance mode. This interface allows an identifier 1202 to be selected for a performer in the performance mode. In this example, the identifier 1202 includes a group identifier (e.g., identified by a letter) and an individual identifier (identified by a number). The combination of group identifier and individual identifier represents a unique performer identifier associated with an individual performer taking part in the performance.

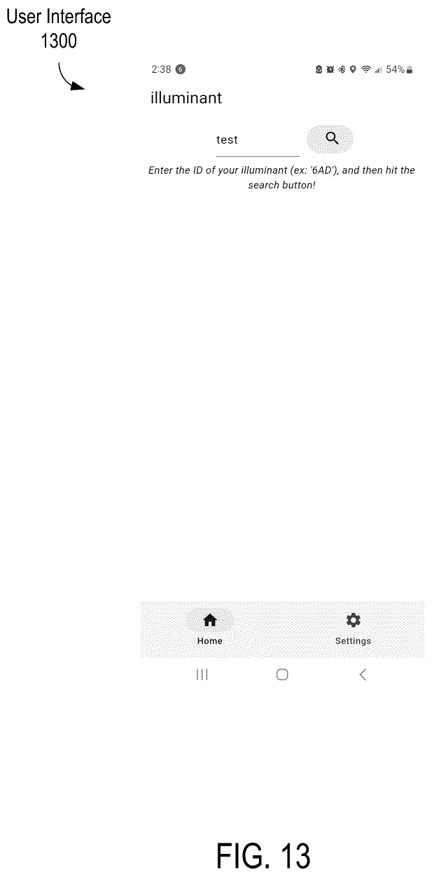

FIG. 13 is a first screen 1300 that is displayed upon opening the application on the mobile device 106, and enabling the user to initiate a connection to a lighting unit 108 (e.g., by entering an identifier associated with the lighting unit 108).

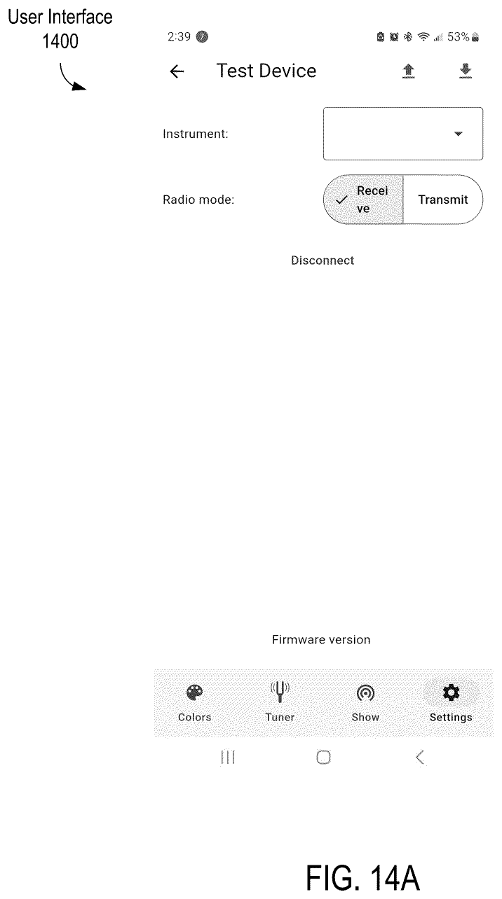

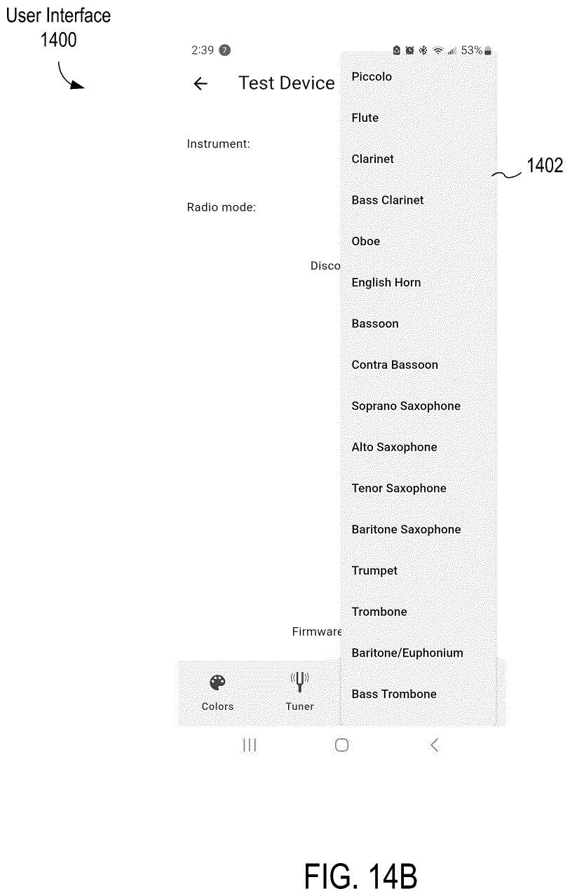

FIG. 14A-B is an example settings page 1400 that enables selection of instrument to be associated with the mobile application and the connected lighting unit 108. The instrument may be selected from a predefined list 1402 (as shown in FIG. 14B) in one embodiment.

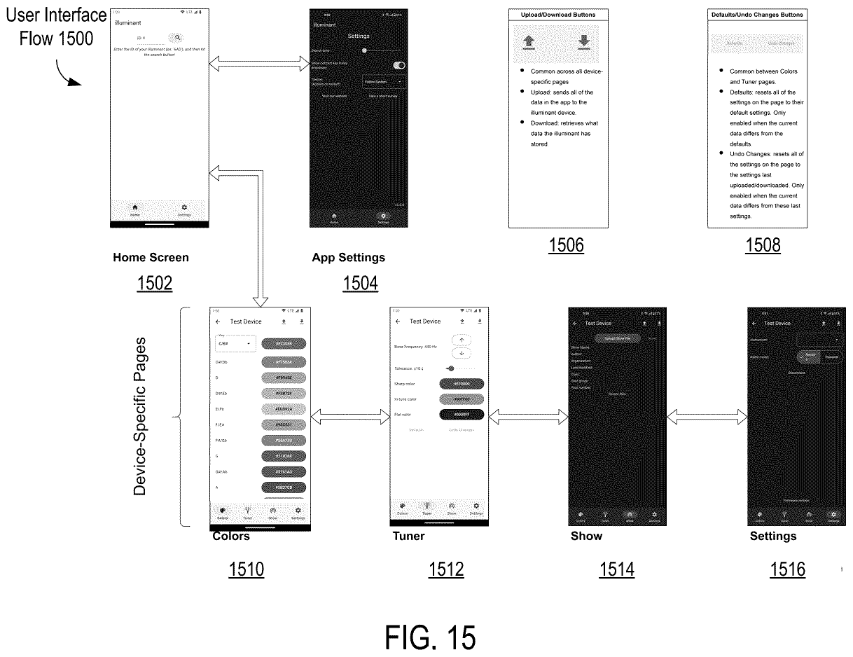

FIG. 15 is an example user interface flow 1500 associated with a mobile application. In this example, the mobile application launches with a home screen 1502 that allows users to search automatically (e.g., via Bluetooth) for nearby lighting units 108 and/or enter an identifier for a lighting unit 108. A setting screen 1504 can be accessed from the home page 1502 and enables configuration of various user-specific settings. Once a lighting unit 108 is connected, various device-specific pages enable configuration of various settings associated with the lighting unit 108. For example, a colors setting page 1510 enables custom colors to be associated with different notes in the note recognition mode and/or change the overall key. The settings screen for the tuner mode 1512 enables configuration of colors that are displayed when the detected pitch is flat, in-tune, or sharp, and furthermore sets tolerances associated with tuning. The show settings page 1514 enables configuration of settings associated with a performance, including uploading a performance file to the lighting unit 108. A basic settings page 1516 enables configuration of various general settings of the lighting unit 108. An upload/download page 1506 may be used to manage uploads and downloads. A defaults/undo page 1508 may enable setting defaults, restoring defaults, or undoing setting changes.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A method for operating a lighting unit attachable to a musical instrument, the method comprising:
obtaining audio samples;
detecting a frequency and amplitude of the audio samples;
discarding samples below a threshold amplitude;
obtaining a musical tone of the audio samples independent of octave based on the frequency;
obtaining a user-configured color mapping between the musical tones and a color; and
configuring an LED of the lighting unit according to the color.
